(19) United States
(12) Patent Application Publication
(10) Pub. No.: US 2026/0155726 A1
(43) Pub. Date: Jun. 4, 2026

(54) SUPERCONDUCTING MOTOR COMPRISING A MOTOR HOUSING WITH SEPARATE COMPARTMENTS FOR INSULATING WINDINGS

(71) Applicant: AIRBUS SAS, Blagnac (FR)

(72) Inventors: Alexandre COLLE, Blagnac (FR); Reda ABDOUH, Blagnac (FR); François DUNOYER, Blagnac (FR)

(73) Assignee: AIRBUS SAS, Blagnac (FR)

(21) Appl. No.: 19/400,912

(22) Filed: Nov. 25, 2025

(30) Foreign Application Priority Data
Nov. 29, 2024 (FR) 2413180

(51) Int. Cl. H02K 55/00; H02K 1/27; H02K 5/04

(52) U.S. Cl. CPC H02K 55/00; H02K 1/27; H02K 5/04

(57) ABSTRACT

A superconducting motor includes a rotor holding permanent magnets and able to rotate about a longitudinal axis, a stator holding windings suitable for being powered in order to generate a magnetic field that rotates the rotor by virtue of the permanent magnets, and a motor housing. The motor housing has a plurality of compartments that are hermetic with respect to each other, each compartment enclosing one or more windings of the stator, each compartment being evacuated in order to form a thermal insulation barrier for the winding or windings enclosed in the compartment in question. As a result, any particles that might detach from a faulty winding do not damage the thermal insulation barrier of any other winding housed in another compartment.

### TECHNICAL FIELD

The present invention relates to the general field of superconducting motors.

### PRIOR ART

As illustrated schematically in FIGS. 1 and 2, a superconducting motor of the prior art comprises a rotor 102 that has a rotor core made from a ferromagnetic material such as the set of iron alloys used for electric machines. The rotor core is generally cylindrical and has a central bore into which a drive shaft 101 is fitted and rigidly fastened. The drive shaft 101 is coaxial with the axis of revolution of the rotor core, superposed on the longitudinal axis X of the superconducting motor.

The rotor 102 also comprises permanent magnets held by the rotor core. There is a plurality of permanent magnets evenly angularly distributed on the periphery of the rotor core and spaced apart from each other. For the sake of simplicity, the permanent magnets are not shown in detail in FIGS. 1 and 2 and are represented by an assembly 112.

The superconducting motor comprises a stator 103 that is arranged around the rotor 102 and comprises a stator core made from a ferromagnetic material such as the set of iron alloys used for electric machines. The stator core has a generally hollow cylindrical shape coaxial with the longitudinal axis X.

The stator 103 comprises a set of a plurality of windings 113 held by the stator core and evenly angularly distributed on the inner periphery of the stator core (so as to face the set of permanent magnets 112) and spaced apart from each other. Each winding 113 consists of a strip of superconducting material. In particular, the strip of superconducting material is wound radially with respect to the longitudinal axis X so as to form one said winding 113.

The rotor 102 and the stator 103 are housed in a motor housing 120 that is cylindrical and closed at its two ends by end walls 121, 122 at least one of which is pierced by a central orifice allowing the drive shaft 101 to pass through. The stator 103 is fixedly mounted inside the motor housing 120, while the assembly formed by the rotor 102 and the drive shaft 101 is mounted free to rotate inside the motor housing 120.

During operation, each winding 113 is powered in order to generate a magnetic field that interacts with the permanent magnets, thus rotating the rotor 102 and the drive shaft 101. A power supply circuit and electronic circuitry for controlling the power supply for powering each winding 113 are installed in one or more control units 130, for example fastened to the motor housing 130. For the sake of simplicity, the electrical connection connecting the power supply and each winding 113 is not illustrated in FIGS. 1 and 2.

The motor housing 120 comprises an inner wall 124 and an outer wall 123. For example, the inner wall 124 and the outer wall 123 are in the form of cylinders that are coaxial with the longitudinal axis X. The inner wall 124 is arranged between the rotor 102 and the stator 103, and the outer wall 123 is arranged around the stator 103 (on the side furthest from the longitudinal axis X). The inner wall 124 and the outer wall 123 extend between the two end walls 121, 122 to which said inner and outer walls are hermetically fastened in order to define between them 123, 124 and the two end walls 121, 122, inside the motor housing 120, a chamber 125 in which the stator 103 and the windings 113 that it holds are housed. This chamber 125 is evacuated and serves to thermally insulate the windings 113 of the stator 103.

If a fault were to occur on a winding 113, particles thereof could detach and there could be a risk of impairment of the thermal insulation performance of the chamber 125. This could have a detrimental effect on the performance of the superconducting motor.

It is therefore desirable to provide a solution that makes it possible to improve the performance of the superconducting motor in the event of a faulty winding.

### DISCLOSURE OF THE INVENTION

To this end, a superconducting motor is proposed herein, comprising a rotor holding permanent magnets and able to rotate about a longitudinal axis, a stator holding windings suitable for being powered in order to generate a magnetic field that rotates the rotor by virtue of the permanent magnets, and a motor housing.

The superconducting motor is such that the motor housing comprises a plurality of compartments that are hermetic with respect to each other, each compartment enclosing one or more windings of the stator, each compartment being evacuated in order to form a thermal insulation barrier for the winding or windings enclosed in the compartment in question.

As a result, by separating the windings in compartments that are hermetic with respect to each other, any particles that might detach from a faulty winding would not damage the thermal insulation barrier of any other winding housed in a different compartment from the compartment housing the faulty winding. The performance of the superconducting motor in the event of a faulty winding is therefore improved.

In one particular embodiment, the superconducting motor is further arranged so that, by virtue of the compartments, each winding is insulated from at least half of the windings of the stator.

In one particular embodiment, the compartments are angularly distributed in a ring around the longitudinal axis.

In one particular embodiment, the compartments are ring portions that are angularly juxtaposed in order to form a ring around the longitudinal axis.

In one particular embodiment, the stator comprises a plurality of sets of windings, each set of windings being arranged in a ring that is coaxial with the longitudinal axis, and the windings of each set are housed in one or more compartments separate from any other compartment used for one or more windings of another said set of windings.

In one particular embodiment, each winding is housed in its own dedicated compartment among said compartments.

In one particular embodiment, each compartment is separated from any adjacent compartment by a wall made from a dielectric material.

An aircraft is also proposed, comprising at least one superconducting motor in any one of the embodiments disclosed above.

### BRIEF DESCRIPTION OF THE DRAWINGS

The aforementioned features of the invention, and others, will become more clearly apparent on reading the following description of at least one exemplary embodiment, said description being given with reference to the appended drawings, in which:

FIG. 1 shows a simplified cross-sectional view of a superconducting motor arrangement according to the prior art;

FIG. 2 shows a simplified top view of the superconducting motor arrangement in FIG. 1;

FIG. 3 shows a simplified top view of a first superconducting motor arrangement according to the invention;

FIG. 4 shows a perspective view of the first superconducting motor arrangement according to the invention;

FIG. 5 shows a simplified cross-sectional view of a second superconducting motor arrangement according to the invention;

FIG. 6 shows a perspective view of the second superconducting motor arrangement according to the invention; and

FIG. 7 shows a perspective view of an aircraft comprising at least one superconducting motor according to the first or second superconducting motor arrangement according to the invention.

### DETAILED DISCLOSURE OF EMBODIMENTS

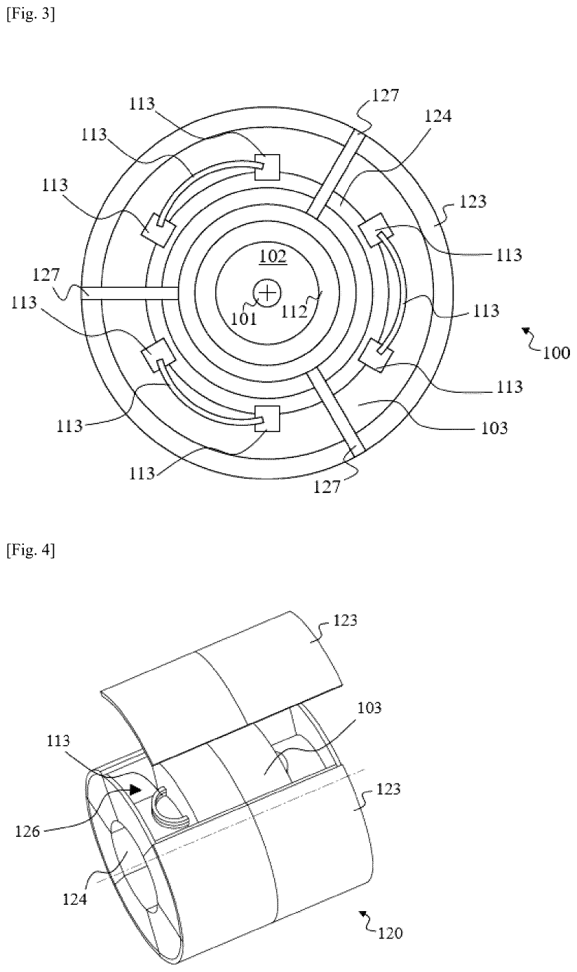

FIGS. 3 and 4 show a first arrangement of a superconducting motor 100 according to the invention.

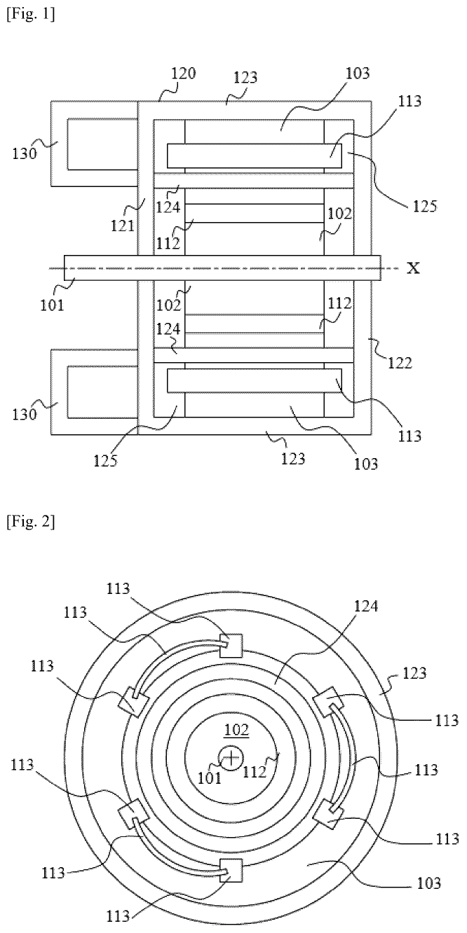

As in FIGS. 1 and 2, the superconducting motor 100 of the first arrangement comprises the rotor 102 with its rotor core, to which the drive shaft 101 is rigidly fastened, and its permanent magnets, together with the stator 103, which is arranged around the rotor 102, with its stator core and its set of windings 113.

The stator 103 is fixedly mounted inside the motor housing 120. The rotor 102 can also be housed in the motor housing. In one embodiment, the motor housing 120 is closed at its two ends by end walls 121, 122, at least one of which is pierced by a central orifice allowing the drive shaft 101 to pass through, and the assembly formed by the rotor 102 and the drive shaft 101 is mounted free to rotate inside the motor housing 120.

The superconducting motor 100 of the first arrangement differs from the superconducting motor in FIGS. 1 and 2 with respect to the formation of the thermal insulation barrier of the windings 113 provided by the vacuum. In the first arrangement in FIGS. 3 and 4, the motor housing 120 comprises a plurality of compartments 126 that are hermetic with respect to each other, each compartment 126 enclosing one or more windings 113 of the stator 103. Conversely, in the arrangement in FIGS. 1 and 2, the windings of the stator are housed in the same chamber 120.

Each compartment 126 is evacuated in order to form a thermal insulation barrier for the winding or windings 113 enclosed in the compartment 126 in question.

More specifically, in the first arrangement, the compartments 126 are angularly distributed in a ring around the longitudinal axis X. In one particular embodiment, the compartments 126 are ring portions that are angularly juxtaposed in order to form a ring around the longitudinal axis X.

For example, the compartments 126 against each other form a crown in which the stator 103 is therefore contained, as illustrated in FIGS. 3 and 4, wherein the inner wall 124, the outer wall 123 and the end walls 121, 122 of the motor housing 120 are formed by the compartments 126 themselves (in FIG. 4, a portion of the outer wall 123 of the motor housing 120 is shown separated from the rest of said outer wall 123 in order to reveal the inside of a compartment 126).

It should be noted that the compartments 126 can be housings that are hermetic with respect to each other and are assembled inside the motor housing 120, that is, the compartments 126 are contained in the space formed by the inner wall 124, the outer wall 123 and the end walls 121, 122 of the motor housing 120.

The windings 113 are thus distributed in at least two separate compartments 126. As a result, if a winding 113 is damaged, this will not affect the thermal barrier of all the other windings 113, which is formed by the vacuum.

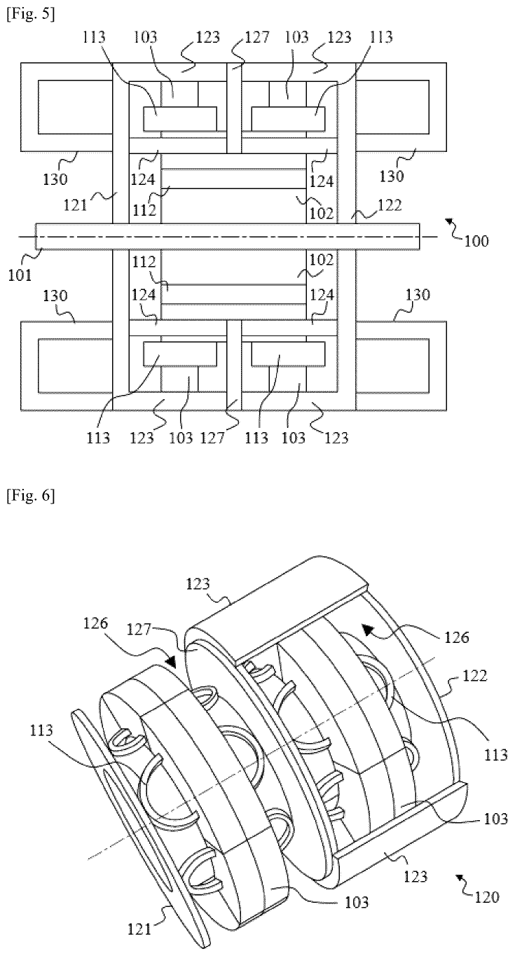

FIGS. 5 and 6 show a second arrangement of a superconducting motor 100 according to the invention, in which the compartments 126 are arranged axially instead of radially.

The superconducting motor 100 of the second arrangement in FIGS. 5 and 6 also differs from the superconducting motor in FIGS. 1 and 2 with respect to the formation of the thermal insulation barrier of the windings 113 that is formed by the vacuum. In the second arrangement, the motor housing 120 also comprises a plurality of compartments 126 that are hermetic with respect to each other, each compartment 126 enclosing one or more windings 113 of the stator 103.

More specifically however, in this second arrangement, the stator 103 comprises a plurality of sets of windings 113, wherein each set of windings 113 is arranged in a ring that is coaxial with the longitudinal axis X. There is thus a plurality of rows of windings 113 on the inner periphery of the stator core (so as to face the set of permanent magnets 112). It should be noted that the permanent magnets can be shared by a plurality of rows of windings 113. In each row, the windings 113 are evenly angularly distributed and spaced apart from each other, in order to form the aforementioned ring.

In this second arrangement, the windings 113 of each set (that is, or each row or ring) are therefore housed in one or more compartments 126 separate from any other compartment 126 used for the winding or windings 113 of another said set of windings 113. Here again, the windings 113 are distributed in at least two separate compartments 126.

For example, each compartment 126 forms a crown in which a ring (a row of windings 113) of the stator 103 is therefore contained, as illustrated in FIGS. 5 and 6, wherein the inner wall 124, the outer wall 123 and the end walls 121, 122 of the motor housing 120 are formed by the compartments 126 themselves (in FIG. 6, a large portion of the outer wall 123 of the motor housing 120 is shown separated from the rest of said outer wall 123 in order to reveal the inside of two juxtaposed compartments 126).

It will be noted that, with the second arrangement, it can be useful to install a greater number of control units 130 to incorporate the power supply circuit and the electronic circuitry for controlling the power supply suitable for powering each winding 113, as illustrated in FIG. 5.

In one particular embodiment applicable to both the first arrangement and the second arrangement, by virtue of the compartments 126, each winding 113 is insulated from at least half of the windings 113 of the stator 103. As a result, if a winding 113 is damaged, the thermal barrier that is formed by the vacuum and protects at least half of the windings 113 is preserved (which should make it possible to preserve at least 50% of the motor power).

In one particular embodiment applicable to both the first arrangement and the second arrangement, each winding 113 has its own dedicated compartment 126, thus insulating it from any other winding 113 of the stator 103. As a result, if a winding 113 is damaged, this will not affect the thermal barrier that is formed by the vacuum and protects each of the other windings 113.

In one particular embodiment applicable to both the first arrangement and the second arrangement, each compartment 126 is separated from any adjacent compartment (among the set of compartments 126) by a wall 127 made from a dielectric material. The thermal insulation provided by each compartment 126 to each winding 113 that it encloses is thus reinforced by the electrical insulation of one compartment 126 from another, which improves the performance of the superconducting motor 100.

It will be noted that the windings 113 can be associated with cryogenic elements in order to exchange heat. For example, these cryogenic elements comprise pipes positioned along the windings 113 through which flows a heat transfer fluid that comes from a heat transfer fluid tank and is driven by any appropriate system, such as a pump. The heat transfer fluid is for example helium gas. In each compartment 126, the thermal insulation barrier is thus formed by a vacuum layer surrounding each winding 113 and each cryogenic element located thereon.

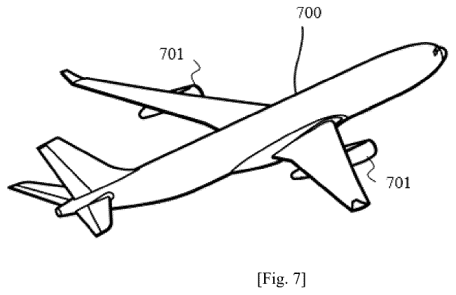

FIG. 7 shows a perspective view of an aircraft 700.

The aircraft 700 comprises at least one superconducting motor 100 according to the first or second arrangement. For example, the aircraft 700 uses such a superconducting motor in each propulsion unit 701, typically for rotating a propeller.

1. A superconducting motor comprising:
a rotor holding permanent magnets and able to rotate about a longitudinal axis (X),
a stator holding windings suitable for being powered in order to generate a magnetic field that rotates the rotor by virtue of the permanent magnets,
a motor housing,
the superconducting motor wherein the motor housing comprises a plurality of compartments that are hermetic with respect to each other, each compartment enclosing one or more windings of the stator, each compartment being evacuated in order to form a thermal insulation barrier for the winding or windings enclosed in the compartment in question.

2. The superconducting motor according to claim 1, further arranged so that, by virtue of the compartments, each winding is insulated from at least half of the windings of the stator.

3. The superconducting motor according to claim 1, wherein the compartments are angularly distributed in a ring around the longitudinal axis (X).

4. The superconducting motor according to claim 3, wherein the compartments are ring portions that are angularly juxtaposed in order to form a ring around the longitudinal axis (X).

5. The superconducting motor according to claim 1, wherein the stator comprises a plurality of sets of windings, each set of windings being arranged in a ring that is coaxial with the longitudinal axis (X), the windings of each set being housed in one or more compartments separate from any other compartment used for the winding or windings of another said set of windings.

6. The superconducting motor according to claim 1, wherein each winding is housed in its own dedicated compartment among said compartments.

7. The superconducting motor according to claim 1, wherein each compartment is separated from any adjacent compartment by a wall made from a dielectric material.

8. The aircraft comprising at least one superconducting motor according to claim 1.
